(19) United States
(12) Patent Application Publication
(10) Pub. No.: US 2015/0120610 A1
(43) Pub. Date: Apr. 30, 2015

(54) Beam Scale Apparatus Implemented for Visual Assessment of Financial Plans

(71) Applicant: FMR LLC, Boston, MA (US)

(72) Inventor: Matthew Kenigsberg, Hingham, MA (US)

(73) Assignee: FMR LLC, Boston, MA (US)

(21) Appl. No.: 14/067,037

(22) Filed: Oct. 30, 2013

(51) Int. Cl. G06Q 40/06

(52) U.S. Cl. CPC G06Q 40/06
USPC 705/36 R

(57) ABSTRACT

A beam scale apparatus, which can be implemented as a physical apparatus or presented as a graphical representation through computer-based system, is provided for visually assessing a financial plan and the impact of changes thereto.

### FIELD OF INVENTION

The invention generally relates to financial planning tools utilized for visual assessment of financial plans and the impact of changes thereto, and more particularly to a beam scale apparatus, which can be implemented as a physical apparatus or presented as a graphical representation through computer-based system.

### BACKGROUND

Financially-inexperienced clients seeking assistance from a financial professional generally do not understand, or do not have the time to understand, key concepts of financial planning, such as the time value of money. Accordingly, a financial professional generally must take time to educate his/her clients on such concepts, including the various factors and risks that must be taken into account during financial planning. Current software and tools for financial planning are generally ineffective, uninformative and/or too complicated to aid in this process. Subsequently, such software and tools generally require the aid of a financial advisor to utilize the software and tools and to analyze and explain the results produced.

### SUMMARY OF THE INVENTION

Embodiments of the invention serve as a financial planning tool for enabling users/clients to visually assess a financial plan for meeting their financial goals (e.g., retirement, education, home buying, etc.) and the impact of changes thereto.

In one embodiment, a beam scale apparatus is provided for visually assessing a financial plan. The beam scale apparatus comprises a fulcrum and a balance beam member disposed on the fulcrum. The balance beam member is capable of receiving one or more weights at predefined distances from the fulcrum. Each of the predefined distances on a first side of the balance beam member correspond to different savings periods, and each of the predefined distances on a second side of the balance beam member correspond to different spending periods. A first weight represents a savings total is positioned on the first side of the balance beam member at a first distance from the fulcrum corresponding to a selected savings period; and a second weight representing a spending total is positioned on the second side of the balance beam member at a second distance from the fulcrum corresponding to a selected spending period. The balance beam member has a pitch that is a function of the first weight being positioned at the first distance from the fulcrum and the second weight being positioned at the second distance from the fulcrum, the pitch visually representing the savings total accrued during the respective savings period relative to the spending total consumed during the respective spending period.

The beam scale apparatus can further comprise a dial indicating a risk level that corresponds to the pitch of the balance beam member. For example, the dial can indicate a lower risk level when the savings total accrued during the selected savings period exceeds the spending total consumed during the selected spending period. Conversely, the dial can indicate a higher risk level when the savings total accrued during the selected savings period fails to satisfy the spending total consumed during the selected spending period.

In other embodiments, a computerized system, method and computer program product are provided for visually assessing a financial plan that comprise structure, steps and instructions, respectively, for calculating a savings total based on a selected savings rate during a selected savings period; calculating a spending total based on a selected spending rate during a selected spending period; and displaying on a display device a graphical representation of a beam scale apparatus having a balance beam member disposed on a fulcrum. The graphical representation of the beam scale apparatus further comprises (i) a first weight, representing the savings total, positioned on a first side of the balance beam member at a first distance from the fulcrum, the first distance corresponding to the selected savings period; (ii) a second weight, representing the spending total, positioned on a second side of the balance beam member at a second distance from the fulcrum, the second distance corresponding to the selected spending period; and (iii) the balance beam member being pitched at an angle on the fulcrum, the angle of the pitch being a function of the relationship between the savings total accrued during the respective savings period and the spending total consumed during the respective spending period, i.e., a function of the savings total accrued during the respective savings period to satisfy the spending total consumed during the respective spending period. In particular, the balance beam member can be (i) pitched at a zero degree angle when the savings total (which can additionally be appropriately adjusted for time, investment return, risk and other factors) accrued during the selected savings period equals the spending total consumed during the selected spending period; (ii) at an angle biased toward the first weight when the savings total accrued during the selected savings period exceeds the spending total consumed during the selected spending period; and (iii) at an angle biased toward the second weight when the savings total accrued during the selected savings period fails to satisfy the spending total consumed during the selected spending period. User-specified values can be received for the selected savings rate, the selected savings period, the selected spending rate and the selected spending period through one or more graphical input tools.

Further, a graphical dial can be displayed on a display device indicating a risk level that corresponds to the pitch of the balance beam member. For example, the graphical dial can indicate a lower risk level when the savings total accrued during the selected savings period exceeds the spending total consumed during the selected spending period. Conversely, the graphical dial can indicate a higher risk level when the savings total accrued during the selected savings period fails to satisfy the spending total consumed during the selected spending period.

In any of the foregoing embodiments, the first weight can be proportional in size to the saving total. The first weight can be a single weight, or graphical representation thereof, representing the savings total accrued during the selected savings period. Alternatively, the first weight can be a plurality of savings weights, or graphical representation thereof, where each of the savings weights representing a savings amount accrued during a respective interval of the selected savings period are positioned on a first side of the balance beam member at a distance from the fulcrum corresponding to the respective interval of the selected savings period.

In any of the foregoing embodiments, the second weight can be proportional in size to the spending total. The second weight can be a single weight, or graphical representation thereof, representing the spending total accrued during the selected spending period. Alternatively, the second weight can be a plurality of spending weights, or graphical representation thereof, each of the spending weights representing a spending amount consumed during a respective interval of the selected spending period are positioned on a second side of the balance beam member at a distance from the fulcrum corresponding to the respective interval of the selected spending period.

Other aspects of the invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention as well as the invention itself, will be more fully understood from the follow description of various embodiments, when read together with the accompanying drawings.

FIG. 1 is an exemplary depiction of a graphical representation of a beam scale apparatus displayable by a computing device for visually assessing a financial plan according to one embodiment.

FIG. 2 is an exemplary depiction of the graphical representation of the beam scale apparatus after manipulating the original target values of FIG. 1.

FIG. 3 is an exemplary depiction of a graphical representation of a beam scale apparatus displayable by a computing device for visually assessing a financial plan according to another embodiment.

FIG. 4 is a flow chart illustrating a computerized method for generating a graphical representation of the beam scale apparatus according to one embodiment.

FIG. 5 is an exemplary depiction of the physical beam scale apparatus for financial planning.

FIG. 6 is an exemplary depiction of the plurality of weights for the beam scale apparatus, representing savings and spending amounts.

### DETAILED DESCRIPTION

Embodiments of a beam scale apparatus are presented herein for visually assessing a financial plan and the impact of changes thereto. Examples of such financial plans can include plans for funding retirement, education, home purchases and general investing. By using beam scale apparatus as a visual metaphor, clients can intuitively grasp financial concepts, such as the time value of money, which can otherwise be difficult to explain. Embodiments of the beam scale apparatus are described herein as capable of implementation as a physical apparatus and as a graphical representation displayable by a computing device. The terms “beam scale apparatus,” “balance beam,” “fulcrum scale” and “scale” are used interchangeably throughout the specification. Similarly, the terms “user” and “client” are used interchangeably throughout the specification.

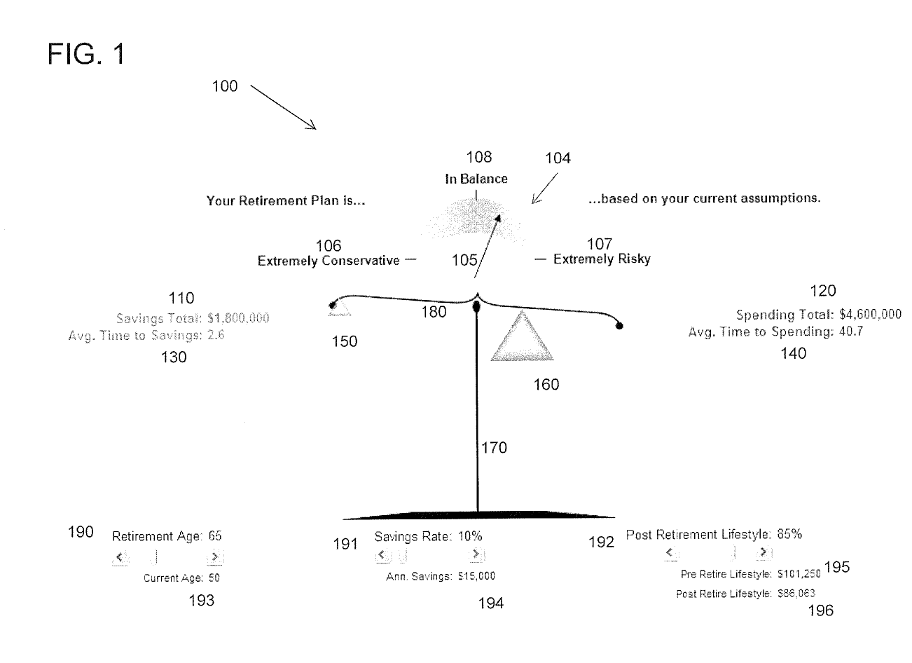

FIG. 1 is an exemplary depiction of a graphical representation of a beam scale apparatus displayable by a computing device for visually assessing a financial plan according to one embodiment. As shown, the graphical representation of the beam scale apparatus 100 comprises a fulcrum 170 and a balance beam member 180 disposed on the fulcrum, with weights 150, 160 disposed on the balance beam member.

A first weight (or savings basket) 150 representing a savings total 110 is shown positioned on a first side (e.g., left side) of the balance beam member at a distance corresponding to a selected savings period 130. Conversely, a second weight (or spending basket) 160 representing a spending total 120 is shown positioned on a second side (e.g., right side) corresponding to a selected spending period 140. The weights can be color coded in a manner to visually distinguish between the savings weight (e.g., green) and the spending weight (e.g., red). Furthermore, the respective sizes of the savings and spending weights can be depicted in the graphical representation as being proportional to the respective savings and spending totals. For example, FIG. 1 clearly shows the savings weight 150, which corresponds to the savings total 110 at $1.8 million, being smaller than the spending weight 160, which corresponds to the spending total 120 at $4.6 million.

As shown in FIG. 1, the balance beam member 180 is pitched at an angle on the fulcrum, the angle being a function of the savings total 110 accrued during the respective savings period 130 to satisfy the spending total 120 consumed during the respective spending period 140. In this example, the balance beam member 180 is pitched at an angle biased toward the spending weight 160 because the spending total 120 consumed during the selected spending period 140 exceeds the savings total 150 accrued during the selected savings period 130. As shown in FIG. 1, then, the balance beam member 180 is pitched at an angle biased toward the spending weight 160, because the weight of the spending total 120 consumed during the spending period 140 exceeds the weight of the savings total 150 accrued during the selected savings period 130. This physical deployment of the elements of the beam scale reflects the mathematics of the underlying financials: even though the average time to saving 130 is much less than the average time to spending 140, there is still not enough time—not enough difference between the two—for the savings total 110 to grow enough to satisfy the much larger spending total 120. Conversely, if the savings total 150 (after correcting for the differing amounts of leverage) accrued during the selected savings period 130 exceeds the spending total 120 consumed during the selected spending period 140, the balance beam member 180 is pitched at an angle biased toward the savings weight 150. Alternatively, if the savings total 110 accrued during the selected savings period 130 equals the spending total 120 consumed during the selected spending period 140, the balance beam member 180 is pitched at a zero angle biased toward the savings weight 150.

In the context of a retirement plan, the savings total 110 is the net total savings (or assets) that the client plans to accrue during the selected savings period 130 prior to retirement, and the spending total 120 is the net total spending (or liabilities) that the client anticipates will be consumed during the selected spending period 140, i.e., during retirement. In general, the spending total will be approximately equal to the annual spending need of the user multiplied by the number of years of anticipated retirement, but it need not be. Spending in retirement may be highly irregular, and/or other variables such as inflation or rate of return may affect the actual spending total. While the beam scale can be used on a very simple level, with only a few simple variables available to the user, it can also accommodate a great deal of complexity, but the nature of the model makes it possible to reveal as much or as little of the underlying complexity as necessary. For example, different types of accounts—taxable, qualified, exempt—can all be entered and treated differently, various sources of outside income in retirement (some nominal and some real) can be incorporated, and even the beneficial effects of an advantageous savings hierarchy can also be taken into account, particularly when using the graphical representation of the beam scale.

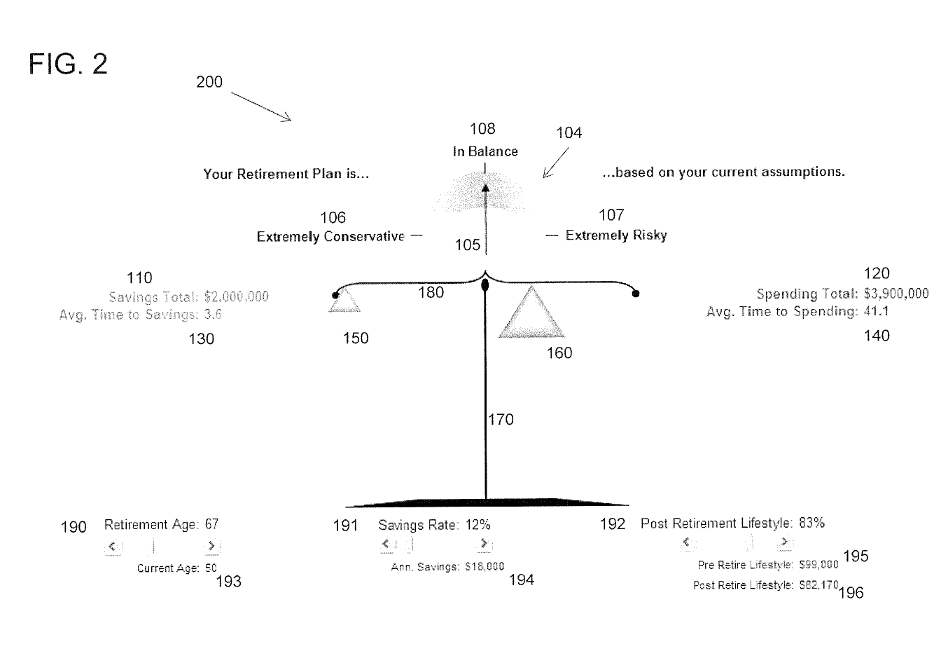

In addition, a graphical dial 104 can be presented, along with the graphical representation of the beam scale apparatus 100, which indicates a risk level. The risk level preferably corresponds to the pitch of the balance beam member. As shown in FIG. 2, the graphical dial 104 having a needle 105 indicating a lower risk level when the savings total accrued during the selected savings period exceeds the spending total consumed during the selected spending period (i.e., pitch is biased towards savings weight 150, or a conservative plan 106). Conversely, the needle of the graphical dial 104 indicates a higher risk level when the savings total accrued during the selected savings period fails to satisfy the spending total consumed during the selected spending period (i.e., pitch is biased towards spending weight 150, or a risky plan 107).

The selected savings period 130 for a retirement plan can be specified as an average time to savings. The average time to savings is the number of years before the average dollar of retirement savings is invested. For example, if a client presently has $1 million in retirement savings and does not plan to invest any more, the average time to savings would be zero. If the client had no money invested now and planned to invest $1 million in five years, the average time to savings would be five. If she had $1 million now and planned to invest another $1 million in five years, then the average time to savings 130 would be 2.5, and so on. Inflation, tax rates, and other assumptions can be incorporated into the model if desired, and they may have an impact on the calculation of the average time to savings and average time to spending.

In the example shown in FIG. 1, the average time to savings is 2.6—which is quite short. Accordingly, the savings weight 150 is positioned very close to the end of the balance beam member. The closer the savings weight 150 is positioned to the end of the balance beam member (away from the fulcrum 170), the shorter the average time to savings. Just as moving a weight to the left on a beam balance would cause the beam to tilt more to the left (or less to the right), shortening the average time to savings—by, for example, saving more now and less later—can cause a retirement plan to be more overfunded (or less underfunded). Likewise, the selected spending period 140 for a retirement plan can be specified as an average time to spending. The average time to spending 140 is the number of years before the average dollar of retirement savings is spent. As the average time to spending increases, the closer the spending weight 160 is positioned to the middle of the balance beam member (and toward the fulcrum 170).

Some variables specific to the user/client that are known and not expected to change can be input into the system as fixed parameters, but they do not need to be. For example, in FIG. 1 the known values entered into this system are the client's current age 193 of which was preset to fifty, and the pre-retirement lifestyle 195 which was preset at annually $101,250. Other fixed parameters, for example may include starting assets, taxable rate, percentage of starting (or incremental saved) assets in qualified tax deferment or exemption, and post-retirement real and/or nominal income, if any is anticipated, including income from outside sources, such as Social Security or private pension plans. These parameters may or may not be available on the primary graphical user interface of the beam scale, as these values may not typically be changed by the user once set. Additionally, there may be other fixed parameters which are set in advance and not generally modified by the user. Examples of these fixed case parameters are assumed inflation, assumed real salary growth, assumed real lifestyle growth, pre-retirement eff income, post-retire eff income tax, tax efficiency, tax management impact, pre-retirement LTCG tax rate, post-retirement LTCG tax rated, def/exp pre-tax nom return, taxable pre-tax nom return, taxable post-tax nom return, tax drag, taxable liquid return of principal, taxable liquid LTCG/total CG, and taxable total liquid tax.

On the other hand, several variables (or target values) specific to the user/client can be input or manipulated through graphical user interface tools in order to alter the savings/spending weights, savings/spending periods and pitch of the displayed beam scale apparatus. For example, in the context of retirement planning, these variables can include the user's/client's retirement age 190, saving rate 191, and post-retirement lifestyle 192. Retirement age 190 is used, in conjunction with the client's current age 193, to determine the number of years available for saving prior to retirement. The savings rate 191 can be defined as an annual percentage of the client's pre-retirement pre-tax earnings 195 to be set aside for annual savings 194. The post retirement lifestyle rate 192 can be defined as an annual percentage of the client's annual pre-retirement lifestyle expenses 195 for determining the client's annual lifestyle expenses after retirement 196.

As shown in FIG. 1, such variables can be initially set as follows:

Planned Retirement Age: 65

Savings Rate: 10%

Post-Retirement Lifestyle: 85%

As discussed above, changes to these target values can be manipulated through graphical user interface tools in order to alter the savings/spending weights, savings/spending periods and pitch of the displayed beam scale apparatus. For example, the user can slide the slider or press the right arrow button on the Retirement Age 190 and input a different scenario. If the retirement age slider 190 is clicked to increase the retirement age, the retirement starting point is delayed by one year for each year increase. As the retirement starting point is pushed further out into the future, there is more time to save, and recalculation of the time to savings then shows the beam 180 tilting a bit less to the right. Eventually, as retirement age is further and further increased, the beam 180 will be level, and at that point the retirement plan is in balance, which is shown visually by both the zero degree pitch of the beam 180 and/or by the needle 105 of the dial 104 pointing towards an In Balance plan 108. In this exemplary scenario, the system can show the user the plan works when then retirement age is raised to 69, with other factors remaining the same. As another example, with the retirement age and savings rate set back to 65 and 10%, respectively, the user can slide the slider or press the right arrow button on the Savings Rate 191 slider and increase the savings rate by 1% increments. The system recalculates the totals and the beam 180 tilts a bit less to the right with each click. Eventually, the beam 180 will be level, again indicating that the plan is feasible or in balance 108. In this exemplary scenario, that happens when the savings rate hits about 27%. In a further example, with the retirement age and savings rate again set back to 65 and 10%, respectively, and the Post Retirement Lifestyle set to 85%, the plan is again out of balance. The user can slide the slider or click the left arrow button on the Post Retirement Lifestyle slider 192, and the value is reduced in 1% increments. The system recalculates the totals and the beam 180 starts tilting less to the right. Once again, the plan will be in balance when the beam is in balance 108, and in this example that happens when the Post Retirement Lifestyle hits 74%.

FIG. 2 is an exemplary depiction of the graphical representation of the beam scale apparatus after manipulating the original target values of FIG. 1. Specifically, the retirement age 190 is increased from 65 to 67, the savings rate 191 is increased from 10% to 12% and the post-retirement lifestyle 192 is decreased from 85% to 83%. As a result, the pitch of the balance beam member 180 shifts from the predicted risky scenario 107 of FIG. 1 to a level position indicating that the client's planned pre-retirement savings and post-retirement spending is in balance 108. Specifically, the longer savings period 130 created by the user pushing out their anticipated retirement starting point 190 combined with a higher savings rate 191 leads to a greater savings total 110 of $2 million. When combined further with a lower post-retirement lifestyle 192 of 83%, bringing the spending total lower 120, the plan comes into balance 108. The combined effect of these three changes brings the plan into balance 108, but each change is much less dramatic than the changes required if only one of the three variables is changed.

Although the client can see the numerical changes in age 190, savings rate 191, post-retirement lifestyle 192, savings total 110, time to savings 130, spending total 120, and time to spending 140, the greater impact is made visually by the growing savings basket 150 and shrinking spending basket 160 and the beam coming into balance 108. Additionally, the user can see the savings total 110 is higher making the green basket 150 or triangle in this case larger as a result of the additional savings. On the other side, the user can see the spending total 120 is lower, and consequently the spending basket 160 or triangle is slightly smaller because the increase in savings 194 leads to a smaller pre-retirement lifestyle 195, and since post-retirement lifestyle 196 is defined as a percentage of pre-retirement lifestyle 195, it too is lowered. The simplicity of the weights on the beam scale apparatus allows the client to understand these complex ideas and calculations quickly and easily.

In some embodiments, the beam level and the dial can be further calibrated or impacted by another variable indicating the level of confidence the user has in the values input, i.e., a predetermined level of confidence. In FIGS. 1 and 2, the level is set to 90%, but this amount can be recalibrated to be any desired confidence level by the user. In other words, if the beam is level and the needle points up, the client's retirement plan is in balance, whether the user chooses to define success for their plan as a 75% confidence level, a 90% confidence level, or some other predetermined level of confidence. If, however, the beam is tilting and the needle is pointing to the right—as is the case with this particular client scenario in FIG. 1—the system then indicates that the retirement plan is not on track to succeed, given the way the client chooses to define success for their plan, i.e., at whatever predetermined level of confidence.

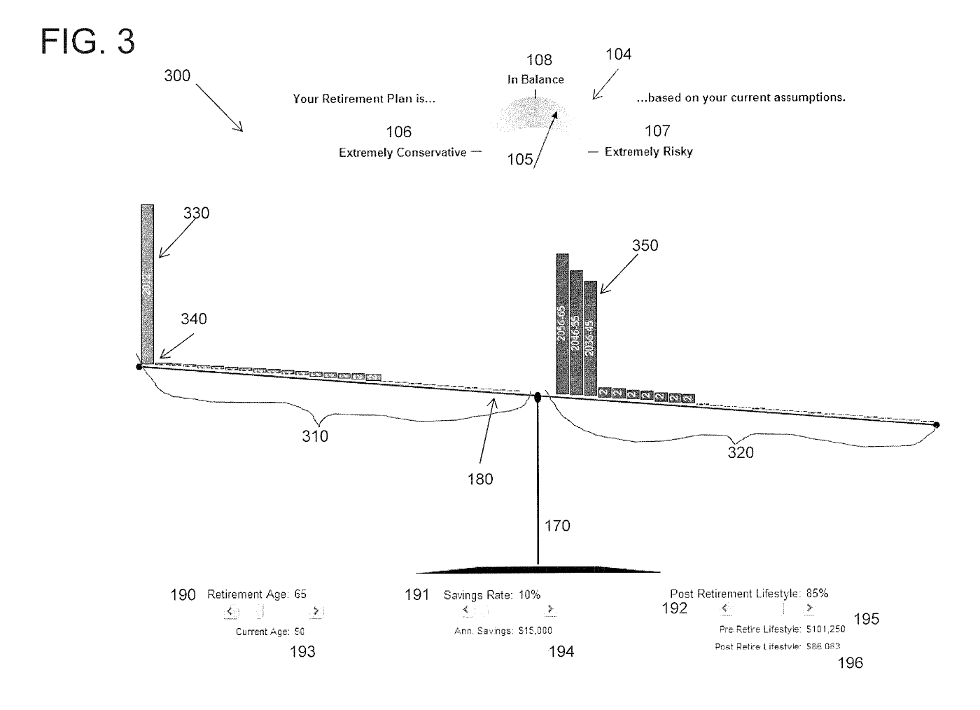

FIG. 3 is an exemplary depiction of a graphical representation of a beam scale apparatus displayable by a computing device for visually assessing a financial plan according to another embodiment. The graphical representation of the beam scale apparatus 300 in FIG. 3 is similar to that of FIGS. 1 and 2, except that the savings weight 150 in FIGS. 1 and 2 is instead represented in FIG. 3 by a set of individual savings weights 310 and the spending weight 160 in FIGS. 1 and 2 is instead represented by a plurality of individual spending weights 320. Specifically, each of the individual savings weights represents a savings amount 310 accrued, actual or planned, during a respective interval within the selected savings period (e.g., specific year) and is positioned on a first side (e.g., left side) of the balance beam member 180 at a distance from the fulcrum 170 corresponding to that respective interval of time. Likewise, each of the individual spending weights representing a spending amount 320 consumed during a respective interval of the selected spending period (e.g., specific year) and is positioned on a second side (e.g., right side) of the balance beam member 180 at a distance from the fulcrum 170 corresponding to that respective interval of time. Thus, the placement of the blocks/weights 310, 320 on each side of the fulcrum 170 can further represent when (e.g. what year or time interval) the assets are saved or on the other hand when (e.g. what year or time interval) the user expects to spend various amounts.

Additionally, as shown in FIG. 3, these weights can be displayed as blocks whose height is representative of the savings (i.e., assets) or spending (i.e., liabilities) at a given time period interval, i.e., the height of each block can be proportional to the respective savings/spending subtotal for a specific time period, shown here in years. As exemplified in FIG. 3, the initial savings in the savings period of the year 2012, representing the user's starting assets and savings for 2012, is higher in height than the subsequent savings weights 340 which are only equivalent to the annual savings 194. Further, as exemplified in FIG. 3, the initial savings 330 in the savings period of the year 2012 is shown larger than the smaller spending amount 350 for the year 2036.

Again, FIG. 3 shows the example retirement plan, via the given scenario input values from the user. As shown, the beam scale apparatus is out of balance 107. With the retirement age 190 set at 65, savings rate 191 at 10% and post-retirement lifestyle 192 at 85%, the beam 180 is still titling to the right, indicating the plan's probability of success is low 107. Again, the user can similarly manipulate some or all of the target variables to adjust their retirement plan, and find a scenario(s) that work best for their goals. Additionally, in this example embodiment, the user may additionally be able to manipulate values for each savings/spending period (e.g. each year interval) instead of just the target values of annual savings 191 and total post retirement lifestyle 192. Again, when the user or client manipulates the scenario, the system recalculates totals, refreshes the representation of the beam 300 and the plurality of weights 310, 320 to correspond to the new input such that the user can see the effects of the new input.

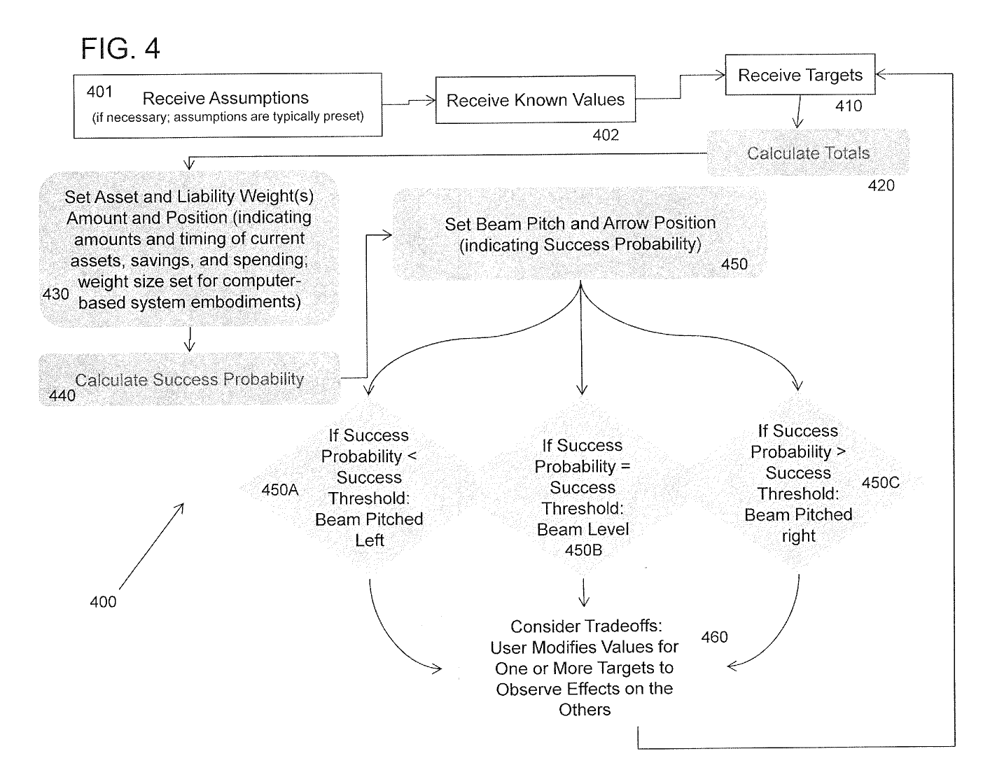

FIG. 4 is a flow chart illustrating a computerized method for generating a graphical representation of the beam scale apparatus according to one embodiment. At 401, the process 400 begins by the system receiving various assumptions about the client's financial situation into the financial planning tool executing on a computing device. These assumptions can include various factors such as success probability threshold, i.e., the success probability considered acceptable to the user and or client. This success probability threshold is then indicated by a level beam pitch. Other assumptions can include, for example in a retirement planning scenario, an inflation rate, real income growth rate, real lifestyle growth rate, pre-retirement dollar-weighted return, post-retirement expected return, post-retirement standard deviation of return, post-retirement outside income, pre-retirement effective tax rate, post-retirement effective tax rate. These assumption values can be entered by the user and generally available for future manipulation, or alternatively, these assumptions can be preset in the financial planning tool by the user on the computing device and retrieved via the system for each calculation. For example, a financial representative may present certain assumption values for the client, or the client himself or herself may preset certain values, which are not particularly specific to each individual user, such as the inflation rate or an anticipated post-retirement effective tax rate. These assumption values can be loaded or received by the system on the computing device.

At 402, other known values are received. These values again can be received from values entered by the user or preset values retrieved by the computing device or other computer-based system. User entry can be via text box input, sliding scale, radio button or other selection methods that allow the user to enter values. Known values can include but are not limited to the user or client's gender, current age, and current assets. Again, these values can be preset in the financial planning tool by the user on the computing device, or these values can be loaded or obtained from an accessible database by the computer device. For example, there may be preset values for an example client so that the financial advisor can provide an example to the client before giving a personalized assessment.

At 410, target values can be received by the system for the user to set up the desired scenario for review. These values are typically entered by the user and manipulated until the user is satisfied with the scenario. Again, user entry can be via text box input, sliding scale, radio button or other selection methods that allow the user to enter values. For a retirement planning scenario example, these target values as described above may include the user or client's retirement age, savings rate, and post-retirement lifestyle. In another embodiment, for example a house financing scenario, target values may include the years to goal where the goal is buying a house, the anticipated savings rate for the down payment or the property, mortgage term in years, and maximum mortgage or maximum mortgage payment per month or per year. Again, these target values can be preset or obtained from an available database to provide an example or otherwise show the capability of the system.

At 420, the system utilizes the inputs received to calculate the values for the scenario, including calculating the total annual savings, pre-retirement lifestyle, post-retirement lifestyle, as well as the total assets for the user or client, i.e., the total amount saved during the given savings period. This total savings amount can be the amount that the user or client anticipates he or she will commit to retirement, which can include both assets already invested and any additional investment anticipated between now and the end of the savings period. The system also calculates the total liabilities, i.e., the total amount anticipated to be spent in the given spending period. This total spending amount is the total net spending that the client anticipates he or she will need to support their spending needs over the anticipated spending period. The system also calculates, if necessary, the total time for savings and the total time for spending. The total time for savings can in some embodiments be the average time to savings, which is the number of years (or other metric used) before the average dollar of savings is invested. The total time for spending can be, in some embodiments, the average time to spending, which is the number of years (or or some other time interval) before the average dollar of savings is spent.

At 430, the system can use the calculated values to set the asset and liability sizes of the asset and liability weights on the graphical representation of the beam scale apparatus. These weights may be depicted as basket, geometric shape or otherwise visually represent a weight on the beam scale apparatus. For the computer-based systems, exemplified in FIGS. 1-3, the asset weight size is representative of the input or calculated total assets of the user or client over the total savings period, and the liability weight size is representative of the input or calculated total liabilities of the user or client over the total spending period. For example, in the retirement context, the asset weight or basket represents the total current assets or the total assets the user or client will save or obtain over a given saving period, i.e., the amount the user or client currently has plus the amount the user or client can save for retirement from a given time until their input target retirement age. Similarly, the liability basket would represent the desired post-retirement lifestyle, i.e., the total amount the user or client anticipates spending during retirement. As another example, in a house purchasing scenario, the asset basket could represent the amount the user or client has or anticipates saving for a house or a down-payment for a house over a given time period, and the liability weight represents the total amount the user or client is targeting to spend on a down payment or a house. In any scenario, the asset weight size is set to represent visually and proportionally the amount of assets the user has or will have, and the liability weight is set to represent visually and proportionally the amount of liability or spending the user or client anticipates over a given period of time.

Further, at 430, the location of the weights on the beam scale apparatus is set by the user on the physical apparatus, or by the system on the computer-based graphical representation of the beam scale apparatus. The position of the weights on the beam scale apparatus give an indication to the user and or client of the timing of the savings and spending given the inputs. The distance of the asset weight(s) 150, 310 from the fulcrum 170 of the beam scale apparatus corresponds to the respective interval of the selected savings period during which the amount is to be saved. The distance of the liability weight(s) 160, 320 from the fulcrum 170 of the beam scale apparatus corresponds to the respective interval of the selected spending period during which the amount is to be spent. In one embodiment, the weight 150, 160 310, 320 is positioned closer to the fulcrum if the time period 130, 140 is longer, and is closer to the ends of the balance beam member 180 if the time period is shorter 130, 140. For example in the retirement scenario, if you have only five years to retire, but wish to be retired for approximately 20 years, the asset weight will be closer to the end of the balance beam member 180, on one side (e.g. right side) of the balance beam member, i.e., further from the fulcrum 170, and the liability weight will be closer to the fulcrum 170 on the other side (e.g. left side) of the balance beam member 180, i.e., further from the end of the other side of the balance beam member 180. In one embodiment, the position of the asset basket on a first side of the balance beam indicates the average time to savings, or the time before the average dollar of savings is invested. The closer to the end of the first side of the beam the asset basket is, the shorter the average time to savings. Similarly, the position of the liability basket on a second side of the balance beam indicates the average time to spending, or the time before the average dollar of savings is spent. The closer to the middle of the beam, i.e., the location of the fulcrum of the scale, the liability basket is, the longer the average time to spending.

At 440, the system calculates the success probability of the scenario provided by the user. There are a variety of calculation methodologies that can be easily inserted into the system and used to determine the success probability of a given scenario, i.e., the probability that the specified spending level can be successfully maintained throughout spending period, given the wealth level at the beginning of the spending period. Specifically for the retirement scenario, there are the same varieties of calculation methodologies that can be easily inserted into the system and used to determine the success probability of a retirement scenario, i.e., the probability that the specified retirement spending level, or anticipated post-retirement lifestyle, can be successfully maintained throughout retirement, given the wealth level at the point of retirement. Among the various calculation methodologies are the methodology described by Prof. Moshe Milevsky of York University in his December, 1904 paper titled “What is a Sustainable Spending Rate? A Simple Answer (That Doesn't Require Simulation),” published by the IFID Centre in Toronto, Canada, the contents of which are hereby incorporated herein in their entirety. Another methodology is described by Dr. Gregory W. Kasten in his July, 2013 article titled “Using a Simplified Deterministic model to Estimate Retirement Income Sustainability,” published in the Journal of Financial Planning, the contents of which are also hereby incorporated herein in their entirety.

At 450, the system sets the pitch of the beam 180 to indicate the success probability of the scenario. The probability of success is thus indicated by the pitch of the beam scale apparatus 180. The balance beam member has a pitch that is a function of the first weight being positioned at the first distance from the fulcrum and the second weight being positioned at the second distance from the fulcrum. The pitch specifically can be a function of the savings total accrued during the respective savings period to satisfy the spending total consumed during the respective spending period. The probability of success can be further depicted by a dial 104 above or located near the beam for emphasis. Specifically, the needle 105 position on the dial 104 can also be set to further indicate to the user the probability of success of their inputted scenario (e.g. conservative plan 106, risky plan 107, or a balanced plan 108). For example, when the system sets the beam to be level 450B and or the dial on the needle is set vertical, the timing and amount of savings and spending are in exact balance 108. However, if the system sets the beam tilting and or the dial on the needle is set pointing to the right 450C indicating the plan is risky, i.e., pointing to the second side 107, the savings plan is not on track to succeed because there are too little assets, or it is too late to saving the necessary assets, or both. If the system sets the beam titling and or the dial on the needle is pointing to the left 450A indicating the plan is conservative, i.e., pointing to the first side 106, the savings plan is more than on track to succeed because there are more assets than needed, or there is more than plenty of time to save the necessary assets, or both to meet the anticipated spending.

Additionally, another factor that can weigh in on the probability of success is a user selected or predetermined level of confidence. Again, the user or client can calibrate the system to be any desired confidence level. If the user or client is, for example, close to retirement, and well aware of the factors and fairly confident in the time periods provided (such as the retirement period from the point of retirement to death given a national average or estimate based on family members) or if the client is extremely risk averse, and willing to work longer and spend less in exchange for certainty, then the user or client may choose to have a 99% confidence level which is further input into calculating the pitch of the beam. Alternatively, the user or client, for example may be in their early years of earning potential and not well aware of the potential time periods and or saving potential, and therefore the system can be recalibrated at a lower confidence level. Similarly, the client may consider the possibility of asset exhaustion in retirement to be a minor risk (perhaps because of an external source of income that covers all critical expenses) and is therefore willing to accept a lower confidence level of say 80%.

At 460, after the asset and liability baskets 150, 160, 310, 320 are set and the pitch of the beam is set, the user can view the results of their inputs via the visual representation of whether their current and anticipated state of affairs is in balance. Thus the user can easily see and gauge the state of their savings plan 460, and grasp what can otherwise be difficult to explain. The user can the choose to modify the input values for one or more of the target values 460, allow the system to recalculate 420-440 and reset the graphical representation of the beam 430, 450-450C and observe the effects and consider the tradeoffs of their changes 460. In this manner, the user can easily understand the state of their savings plan or readiness at a glance, and very quickly and easily determine the impact of any changes to their plan 460.

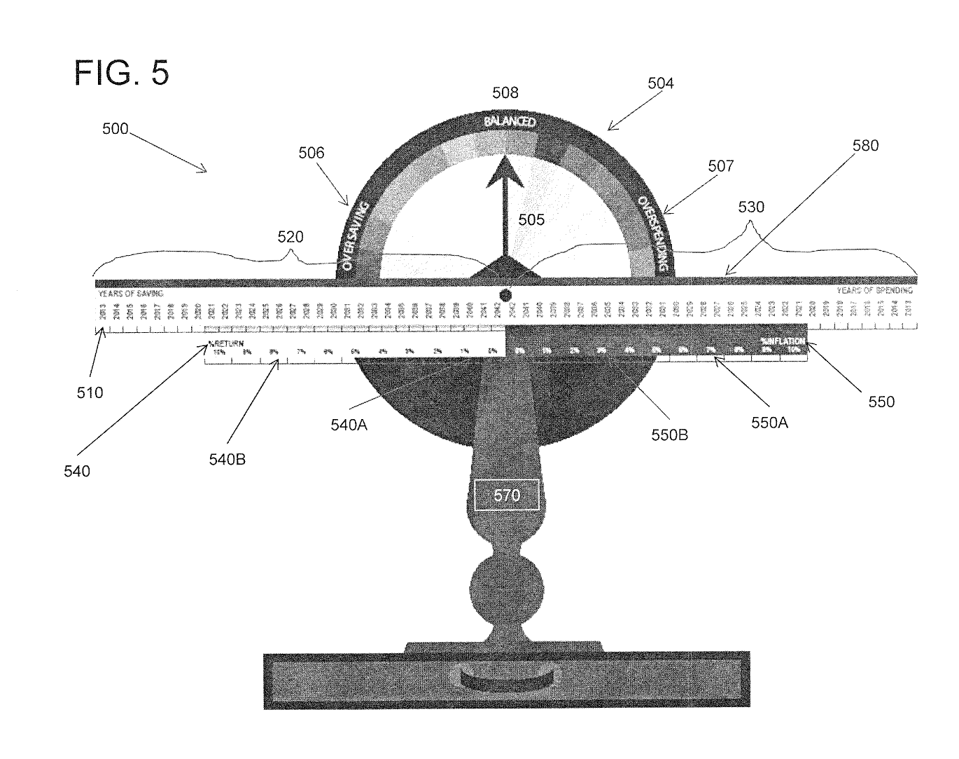

FIG. 5 is an exemplary depiction of the physical beam scale apparatus 500 for financial planning. This example of the mechanical beam scale apparatus 500 exemplifies a similar embodiment to that of FIGS. 1-3 where a plurality of weights are placed on the beam member 580 on either side of the fulcrum 570 to represent assets saved in different years and amounts spent in different years. For example, the user might have accumulated a total of $2,000,000 in savings, so this would be broken out into the current asset amount saved, for example $500,000, and then the anticipated savings amounts for each remaining year up unto the goal year. The user would then place, for example, a $500 k weight on the first year 510 to represent the current amount of assets saved, and then the user would position a $20 k weight on each subsequent year 520. Likewise, the user would place anticipated spending amounts for each year on the other side 530, i.e., the right side to show the liabilities.

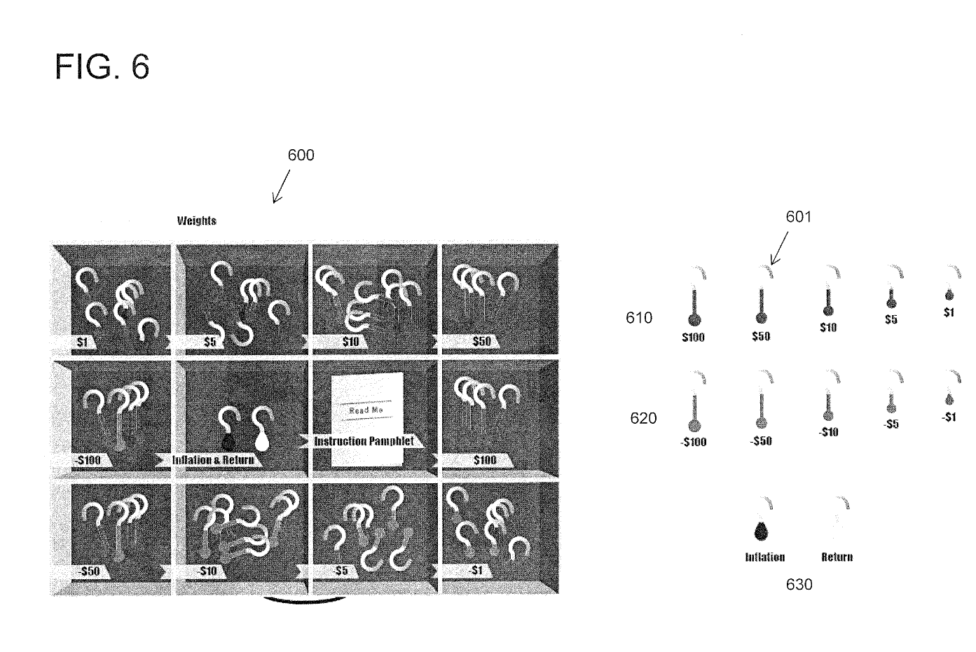

The user can adjust the scenario further on the physical apparatus by placing a weight or weights on the beam member 580 to reflect a certain percentage of return 540. For example, if the user has assets only in a savings account, the user might add a weight to the 1% rate of return on investment 540A to reflect the low savings rate provided by his or her bank. On the other hand, the user might have his or her assets in the stock market or high return CD and would then deploy a weight on the 8% rate of return on investment 540B. Similarly, if the user wants to anticipate levels of inflation, the user can adjust the scenario on the physical beam apparatus 500 by deploying a weight on the scale to represent a percentage of inflation 550. For example, if the user anticipates high levels of inflation, the user can place a weight at 7% rate of inflation 550A. On the other hand, if the user anticipates low levels of inflation, the user can place a weight at 3% rate of inflation 550B. Of course, for either rate of return or rate of inflation, another aspect may be where the user deploys multiple weights for either the rate of return or rate of inflation—various combinations of weights can be used to represent fractional values. When the user has completed deploying weights (e.g. weights shown in FIG. 6), the user will see the probability of success 450 of the scenario inputted on the physical beam apparatus 500. For example, either the scenario or plan input by the user is in balance 508 by the dial 504 on the beam scale apparatus 500 with the needle 505 pointing towards balanced 508 when the beam is level 450B. Alternatively, the user will see that the scenario is conservative when the beam is pitched to the left 450A, i.e., the user is over saving shown also by the needle 505 pointing towards conservative 506. Otherwise, the user will see that the scenario is risky when the beam is pitched to the right 450C, i.e., showing the user is overspending shown also by the needle 505 pointing towards risky 507. Again, the user can easily determine whether their savings plan is in balance, via the pitch of the beam member 580 and/or the needle 505 indication on the dial 504, and can easily adjust 460 the variables (e.g. the weights) in their plan to determine a plan that will be in balance or that does fit their goals.

FIG. 6 is an exemplary depiction of the plurality of weights for the physical beam scale apparatus, representing savings and spending amounts. These exemplary weights 600 can be deployed onto the beam scale apparatus by the hooks being hung from the mechanical beam in holes provided for each savings time period 520, spending time period 530, or hole provided for rate of return 540 or inflation 550. Alternatively, these weights 600 may hang from the beam scale apparatus by another method, i.e. by clips or magnets or other various forms for attachment, or placed on top of the beam scale apparatus 580. These weights provided may be scaled to the user's preference. For example a $50 weight 601 may be $50, $500, $5,000, $50,000 or $50,000,000; however the user chooses to define the weighted values. Additionally as shown in FIG. 6, positive weights 610 can be used only to represent assets saved. In a further embodiment, these asset weights may be colored to indicate further to the user that these are asset weights (e.g. green). Alternatively, negative weights 620 can be used only to represent liabilities and or spending. Similarly, these liability weights may be colored to further indicate to the user that these are liability weights (e.g. red). Additionally, the inflation and return weights 630 may have different weights available for the different percentages or return or inflation. As exemplified in FIG. 6, these weights may alternatively just be one weight. Similar to the asset and liability weights, the inflation and return weights may be colored to indicate to the user which is which (e.g. black and white, respectively).

Alternatively, the user may calculate the totals calculated by the system 420, and place only put one weight 430 on the one side (e.g. right side) of the beam scale apparatus that represents the total savings or total assets to be saved over the total savings period, and deploy 430 on the other side (e.g. left side) of the beam scale apparatus only one weight that represents the total liabilities or total spending amount to be spent over the total savings period. Similar to the embodiment in FIGS. 1-2, the placement of each weight on the asset side 520 and the liability side 530 will depend on calculated average time to savings and average time to spending.

Additionally, the above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system (e.g., a cloud-computing system) that includes any combination of such back-end, middleware, or front-end components. The above described techniques can be implemented as a Software-As-A-Service (SaaS) model or using a multi-tiered approach.

Communication networks can include one or more packet-based networks and/or one or more circuit-based networks in any configuration. Packet-based networks can include, for example, an Ethernet-based network (e.g., traditional Ethernet as defined by the IEEE or Carrier Ethernet as defined by the Metro Ethernet Forum (MEF)), an ATM-based network, a carrier Internet Protocol (IP) network (LAN, WAN, or the like), a private IP network, an IP private branch exchange (IPBX), a wireless network (e.g., a Radio Access Network (RAdN)), and/or other packet-based networks. Circuit-based networks can include, for example, the Public Switched Telephone Network (PSTN), a legacy private branch exchange (PBX), a wireless network (e.g., a RAN), and/or other circuit-based networks. Carrier Ethernet can be used to provide point-to-point connectivity (e.g., new circuits and TDM replacement), point-to-multipoint (e.g., IPTV and content delivery), and/or multipoint-to-multipoint (e.g., Enterprise VPNs and Metro LANs). Carrier Ethernet advantageously provides for a lower cost per megabit and more granular bandwidth options.

Computing devices can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer, mobile device) with a World Wide Web browser (e.g., Microsoft® Internet Explorer® available from Microsoft Corporation, Mozilla® Firefox available from Mozilla Corporation).

One skilled in the art will realize the technology can be embodied in other specific forms without departing from the spirit or essential characteristics thereof. The foregoing embodiments are therefore to be considered in all respects illustrative rather than limiting of the technology described herein. All changes that come within the meaning and range of equivalency of the claims are therefore intended to be embraced therein.

1.-7. (canceled)

8. A computerized method for visually assessing a financial plan, the method comprising:
calculating, by a computing device, a savings total based on a selected savings rate during a selected savings period;
calculating, by the computing device, a spending total based on a selected spending rate during a selected spending period;
generating, by the computing device, on a display device a graphical representation of a beam scale apparatus having a balance beam member disposed on a fulcrum;
positioning, by the computing device, on the display device a graphical representation of a first weight representing the savings total, the first weight being positioned on a first side of the balance beam member at a first distance from the fulcrum, the first distance being directly related to a duration of the selected savings period;
positioning, by the computing device, on the display device a graphical representation of a second weight representing the spending total, the second weight being positioned on a second side of the balance beam member at a second distance from the fulcrum, the second distance being inversely related to a duration of the selected spending period; and
setting, by the computing device, on the display device a pitch of the balance beam member at a pitch angle on the fulcrum, the pitch angle being a function of the savings total accrued during the selected savings period relative to the spending total consumed during the selected spending period, wherein the pitch angle is:
zero degrees when the savings total accrued during the selected savings period is in balance with the spending total consumed during the selected spending period;
biased toward the first weight when the savings total accrued during the selected savings period exceeds the spending total consumed during the selected spending period; and
biased toward the second weight when the spending total consumed during the selected spending period exceeds the savings total accrued during the selected savings period.

9. The computerized method of claim 8 further comprising displaying, by the computing device, on the display device the first weight proportional in size to the savings total and the second weight proportional in size to the spending total.

10.-12. (canceled)

13. The computerized method of claim 8 further comprising:
displaying, by the computing device, on the display device a graphical dial indicating a risk level that corresponds to the pitch of the balance beam member, wherein the graphical dial indicates a lower risk level when the savings total accrued during the selected savings period exceeds the spending total consumed during the selected spending period and the graphical dial indicates a higher risk level when the spending total consumed during the selected spending period exceeds the savings total accrued during the selected savings period.

14. The computerized method of claim 8 further comprising:
receiving, by the computing device, user-specified values for the selected savings rate, the selected savings period, the selected spending rate and the selected spending period through one or more graphical input tools.

15. The computerized method of claim 8 wherein the first weight is a graphical representation of a single savings weight representing the savings total accrued during the selected savings period.

16. The computerized method of claim 8 wherein the first weight is a graphical representation of a plurality of savings weights, each of the savings weights representing a savings amount accrued during a respective interval of the selected savings period, each of the savings weights positioned on a first side of the balance beam member at a distance from the fulcrum corresponding to the respective interval of the selected savings period.

17. The computerized method of claim 8 wherein the second weight is a graphical representation of a single spending weight representing the spending total accrued during the selected spending period.

18. The computerized method of claim 8 wherein the second weight is a graphical representation of a plurality of spending weights, each of the spending weights representing a spending amount consumed during a respective interval of the selected spending period, each of the spending weights positioned on a second side of the balance beam member at a distance from the fulcrum corresponding to the respective interval of the selected spending period.

19. A computer program product, tangibly embodied in a non-transitory computer readable storage device, for visually assessing a financial plan, including instructions being operable to cause a data processing apparatus to:
calculate a savings total based on a selected savings rate during a selected savings period;
calculate a spending total based on a selected spending rate during a selected spending period;
generate on a display device a graphical representation of a beam scale apparatus having a balance beam member disposed on a fulcrum;
position on the display device a graphical representation of a first weight representing the savings total, the first weight being positioned on a first side of the balance beam member at a first distance from the fulcrum, the first distance being directly related to a duration of the selected savings period;
position on the display device a graphical representation of a second weight representing the spending total, the second weight being positioned on a second side of the balance beam member at a second distance from the fulcrum, the second distance being inversely related to a duration of the selected spending period; and
set on the display device a pitch of the balance beam member at a pitch angle on the fulcrum, the pitch angle being a function of the savings total accrued during the selected savings period relative to the spending total consumed during the selected spending period, wherein the pitch angle is:
zero degrees when the savings total accrued during the selected savings period is in balance with the spending total consumed during the selected spending period;
biased toward the first weight when the savings total accrued during the selected savings period exceeds the spending total consumed during the selected spending period; and
biased toward the second weight when the spending total consumed during the selected spending period exceeds the savings total accrued during the selected savings period.

20. (canceled)
